(19) United States
(12) Patent Application Publication
(10) Pub. No.: US 2009/0007201 A1
(43) Pub. Date: Jan. 1, 2009

(54) Jitter Introduction In A Data Transmission System

(75) Inventors: Onno Eerenberg, Eindhoven (NL); Hilmar Van Der Kooij, Nijmegen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,760

(22) PCT Filed: Dec. 10, 2004
(86) PCT No.: PCT/IB04/52748

§ 371 Date: Jun. 23, 2006

(30) Foreign Application Priority Data
Jan. 7, 2004 (EP) 04100017.5

(51) Int. Cl. H04N 7/173

(52) U.S. Cl. 725/104

(57) ABSTRACT

Disclosed is a transmission system comprising a transmitter, at least one receiver and a data network coupling the transmitter and the receiver, whereby the at least one receiver comprises a dejitter mechanism. The transmitter comprises jitter means for introducing jitter into data on the network, and the dejitter mechanism is provided with a jitter control input for controlling an extent of dejitter. In pay per view applications this provides a means for gradually controlling the video and audio quality at the customers' premises.

The present invention relates to a transmission system comprising a transmitter, at least one receiver and a data network coupling the transmitter and the receiver, whereby the at least one receiver comprises a dejitter mechanism.

The present invention also relates to a transmitter, a receiver, a method for the reception of data comprising jitter and to a method for transmission of data, whereby after receipt of the data the jitter is removed.

Such a transmission system is known from WO 02/093938. In the prior art transmission system data packets containing time stamps, or PCR's, are transmitted from a transmitter through a data network to a receiver. The data packets form a coded representation of a video, audio and/or other transport data stream. Each data stream may have its own time base. For example a subscription TV system may comprise a video stream and an associated audio stream. These streams may be combined into a single, so called Moving Picture Expert Group (MPEG) type transport bit stream suitable for transmission through the data network. Generally each data packet contains a header portion and a payload portion containing the encoded data of the stream concerned. Each group of transport data stream packets that contains the same representation of coded data are assigned the same unique Packet Identifier (PID) included in the header portion.

The transmitter is provided with a time stamp means for generating so called Program Clock Reference (PCR) values, also included in a further header portion and originally derived from an actual time base of a counter coupled to a clock generator of an encoder present in the transmitter. Possibly varying delays are experienced for example during a multiplexing at the transmitter or during transmission through the data network. In particular in an Asynchronous Transfer Mode (ATM) network, which allows a multiplexing of packets comprising different data representations, as allowed by the MPEG-1 or the MPEG-2 standard, temporal locations of the data stream packets may change. This results in jitter experienced at the receiver and consequently a reliable receiver clock signal for the time base cannot be re-established. Thereto in the receiver a time base regenerator calculates a time difference between received transmission time stamps, and the time difference is then used to correct the jitter of the local receiver clock signal.

It is an object of the present invention to provide an improved transmission system whose application area and functionality in particular in relation to pay per view applications are extended.

Thereto in the transmission system according to the invention the transmitter comprises jitter means for introducing jitter into data on the network, and the dejitter mechanism is provided with a jitter control input for controlling an extent of dejitter.

It is a merit of the transmission system according to the present invention that jitter although unwanted and normally reduced can now be used in favour of broadening the application area by deliberately introducing jitter at the transmitter or broadcasters' side in order to control the extent of dejitter at the receiver. Consequently pay per view like systems may benefit therefrom, because the dejitter control also allows for the control of the quality of sound and/or video presented to a customer using the system. In the context of paid services, a low frame rate and associated audio and/or quality resulting from a poor dejitter works as a kind of teaser or appetizer for customers to pay for the full services offered by a service provider. Upon request by the customer dejittering will be controlled such that a service in original quality can be provided to those customers who are willing to pay for that full quality service.

An embodiment of the transmission system according to the invention is characterised in that the jitter means are arranged for a stepwise control of the introduced jitter.

Consequently the dejitter means are arranged for a stepwise control of the extent of dejitter.

A further embodiment of the transmission system according to the invention is characterised in that the data network is a network having a fixed or a non fixed delay.

Advantageously the transmission system according to the invention can be combined with systems applying known delay and jitter compensation techniques. The controllable dejitter means here introduced can then be combined with these known techniques in one dejitter device.

A preferred embodiment of the transmission system according to the invention is characterised in that the transmission system is a pay per view system.

At present the transmission system according to the invention and the transmitter and the receiver for application therein will be elucidated further together with their additional advantages, while reference is being made to the appended drawing, wherein similar components are being referred to by means of the same reference numerals. In the drawing:

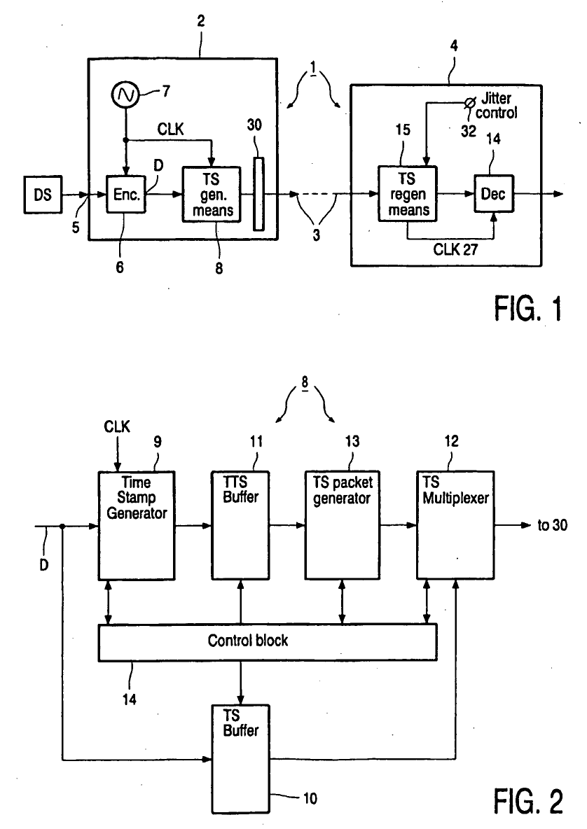

FIG. 1 shows an embodiment of the transmission system according to the invention;

FIG. 2 shows an embodiment of the time stamp generator means in the transmitter, which is suitable for application in the transmission system of FIG. 1; and

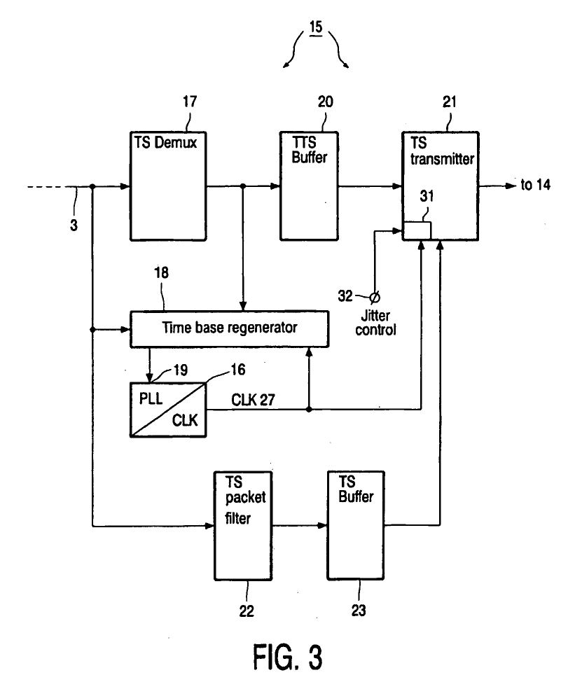

FIG. 3 shows an embodiment of the time stamp regenerator means in the receiver, which is suitable for application in the transmission system of FIG. 1.

FIG. 1 shows a transmission system 1 comprising a transmitter 2 coupled to a transport network or communication channel 3, and one or more receivers—only one such receiver 4 is shown in FIG. 1—coupled to the transport network 3. The transmitter 2 is capable of sending data, in the form of data packets through the network to the receiver 4. The transport network 3 may be a data packet switched network, containing for example a coax, fibre optical, satellite, beam connection or satellite communication link. The transmitter 2 has an input 5 which is coupled to a data source DS, for example in the form of a camera providing a data packet stream comprising a video payload and, possibly combined, a data packet stream comprising an audio payload. These packet streams may be separate or multiplexed data packet streams. Each data packet stream is transmitted to the receiver 4 in coded form. The transmitter 2 comprises an encoder 6 coupled to the input 5. The encoder may be an MPEG encoder 6 to provide video and/or audio transport data stream packets on its data output D for transmission through the network 3. The encoder 6 is coupled to a transmitter clock generator 7, usually generating a 27 MHz clock signal. The transmitter 2 is further provided with transmission time stamp generator means 8 coupled to the encoder 6 and to the clock generator 7.

Transmission time stamp generator means 8 are further shown in FIG. 2 and comprise a time stamp generator 9, which determines based on the local clock signal CLK, the local transmission time of every data transport stream (TS) to form generated transmission time stamps TTS of a transmitted data packet. These time stamps TTS may—as will be explained later—together with other kinds of header data be combined. The time stamps may be combined such that a time stamp data packet contains a possible succession of time stamps, whereby each time stamp is related to respective transmission stream packets. After encoding in encoder 6 the various video and audio data form a transport stream, which is stored in TS buffer 10 coupled to encoder output D. Similarly the transmission time stamps TTS are stored in a TTS buffer 11 coupled to the time stamp generator 9. The transmitter 8 further comprises a possible TS multiplexer 12 coupled to the buffers 10 and 11 respectively in order to provide a full data signal for transmission over the transport network 3. Possibly between the TTS buffer 11 and the TS multiplexer 12 there is coupled a TS packet generator 13 for combining several TTS data blocks, which may or may not be multiplexed with TS data from buffer 10. A usually programmable control block 14 is provided to control the proper sequence of events and operations in the transmitter 2.

The receiver 4, shown in FIG. 1, receives the full data signal in the form of data packets, which are transmitted over the network 3. The TS data packets are decoded by a decoder 14 to recover the video and audio signal originating from data source DS. Decoding takes place based on a local receiver clock signal CLK 27, which is recovered by means of well known PCR values in the transport stream, which PCR values are left unchanged.

The TS regenerator means 15, which are further detailed in FIG. 3, comprise a clock generator 16, usually in the form of a Phase Locked Loop (PLL) for providing the CLK 27 clock signal, which provides the time base for a dejitter function implemented at the receiver 4 in the TS regenerator means 15, which function will be described in further detail hereinafter. For a reliable and accurate decoding in the decoder 14 it is important that the transmitter and receiver clock generators 7 and 16 respectively provide respective clock signals having frequencies matching as closely as possible, else the decoding will lead to data failures. This means that the time base at the receiver 4 has be recovered from the received data packets as accurate as possible.

The TS means 15 comprises a transport stream (TS) demultiplexer 17 for recovering the transmitted transmission time stamps TTS. These time stamps and in particular the difference between consecutive time stamps provides information about the clock frequency of the signal CLK at the transmitter 2. The time difference is calculated in a time base regenerator 18, which is coupled to the TS demultiplexer 17, and this time difference is being used to drive the clock generator 16 at its frequency control input 19. This results in a frequency control of the clock generator 16, such that its frequency closely matches the frequency of the clock signal CLK in the transmitter 2, which in turn results in an accurate and reliable time base for transmission of the TS data packets to the decoder 14. The transmission time stamps TTS may be buffered by buffer 20 before being fed to a transport stream transmitter 21. The transport stream TS data is derived from the network data packages through a TS packet filter 22 and then through a TS buffer 23 also fed to the transmitter 21 to provide the decoder input signal. Again the buffers 20 and 23 allow some delay arising between the processing of the transmission time stamps and the transport stream TS or payload data.

Generally in order to ensure reliable data packet communication over the transport network 3, some kind of check is performed at the network receiver 4 to determine the correctness of the received data. This is important because any mistake in a received transmission time stamp results in faulty data for generating the time base. A possible check is the cyclic redundancy check which is performed over the received data packet. Such a check is capable of indicating faulty data and/or capable of correcting the faulty data.

Preferably some form of indication means implemented in the TS transmitter 21 is provided to ensure that the transmission time stamp TTS received at the receiver 4 refers to its associated data packet. Such means or measures may be embodied by a label containing a continuity count CC, and a data packet identifier PID. If the CC and the PID are digitally combined to form a label then its value can be used as a reference to the main header portion of an associated transport stream packet. Misalignments, which are due to packet loss can thus be detected.

As further shown in FIG. 1 the transmitter 2 comprises jitter means 30 for introducing jitter control information into data output from the multiplexer 12. The jitter is introduced by the jitter means 30 deliberately by varying the transmission time stamp TTS in the data packets in a controlled way, and the amount of introduced jitter may, either stepwise, or continuously be controlled. After the introduction of jitter in the transmitted data the data is somehow conveyed to the network 3 and received by the receiver 4. If the introduced jitter is not compensated the result for a customer at the receiver site would be a lowered playback quality. This however challenges the customer to request a full quality service, which has to be paid for. The means 15, in particular the TS transmitter 21 (see FIG. 3), which includes a dejitter mechanism 31 are provided with a jitter control input 32. A jitter control signal, which is either an analog signal or a digital signal, on input 32 is remotely controlled by the transmitter 2 in particular the jitter means 30, such that the amount of jitter deliberately introduced by the jitter means 30 may be derived from the transmission time stamps TTS, such that it can be used by the dejitter mechanism 31. The introduced jitter control information may for example be included somewhere in the header of the data packets sent over the network 3, which may provide a fixed or a non fixed delay. Consequently this jitter control information may be derived from the header after receipt and processing by the receiver 4, where after it will be applied as a jitter control signal to the jitter control input 32 in order to control the dejittering.

Whilst the above has been described with reference to essentially preferred embodiments and best possible modes it will be understood that these embodiments are by no means to be construed as limiting examples of the devices concerned, because various modifications, features and combination of features falling within the scope of the appended claims are now easily within reach of a skilled person.

1. A transmission system (1) comprising a transmitter (2), at least one receiver (4) and a data network (3) coupling the transmitter (2) and the receiver (4), whereby the at least one receiver (4) comprises a dejitter mechanism (31), the transmitter (2) comprising jitter means (30) for introducing jitter into data on the network (3), the dejitter mechanism (31) being provided with a jitter control input (32) for controlling an extent of dejitter.

2. The transmission system (1) according to claim 1, characterised in that the jitter means (30) are arranged for a stepwise control of the introduced jitter.

3. The transmission system (1) according to claim 1, characterised in that the dejitter mechanism (31) is arranged for a stepwise control of the extent of dejitter.

4. The transmission system (1) according to claim 1, characterised in that the data network (3) is a network having a fixed or a non fixed delay.

5. The transmission system (1) according to claim 1, characterised in that the transmission system (1) is a pay per view system.

6. A transmitter (2) for use in the transmission system (1) according to claim 1.

7. A receiver (4) for use in the transmission system (1) according to claim 1.

8. A method of reception of data comprising jitter, whereby after receipt of the data the jitter is removed, wherein upon transmission the jitter is deliberately added to the data.

9. A method of transmission of data, whereby after receipt of the data the jitter is removed, wherein upon transmission the jitter is deliberately added to the data.

10. The method according to claim 8, characterised in that the extent of deliberately added jitter is included as jitter control information in the transmitted data.
